(19) United States
(12) Patent Application Publication
(10) Pub. No.: US 2006/0176166 A1
(43) Pub. Date: Aug. 10, 2006

(54) Brake controller with manually adjustable accelerometer

(76) Inventors: Bruce E. Smith, Leo, IN (US); Larry Eccleston, Marshall, MI (US); William A. Demerly JR., Huntertown, IN (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/260,589

(22) Filed: Oct. 27, 2005

Related U.S. Application Data
(60) Provisional application No. 60/622,434, filed on Oct. 27, 2004.

(51) Int. Cl. B60Q 1/44

(52) U.S. Cl. 340/479

(57) ABSTRACT

Brake controllers typically require a microprocessor or some complex digital circuitry to achieve a proportional brake control signal suitable to control electric brakes on a towed vehicle. These components can be difficult to manufacture and can be expensive. Therefore, a brake controller comprises a case, a positioning member held by the case, and an accelerometer attached to the positioning member, wherein the positioning member is moveable to position the accelerometer in an operable position

### CROSS-REFERENCE TO RELATED APPLICATIONS

This application claims priority from U.S. Provisional Patent Application No. 60/622,434 filed on Oct. 27, 2004, which is hereby incorporated by reference.

### FIELD OF THE INVENTION

The present invention relates generally to a brake controller, and more specifically, to a brake controller utilizing low cost analog or digital circuitry with a solid-state accelerometer attached to a positioning member.

### BACKGROUND OF THE INVENTION

Conventional prior art for brake controllers typically require a microprocessor or some complex digital circuitry to achieve a proportional brake control signal suitable to control electric brakes on a towed vehicle. Such brake controllers often utilize accelerometers mounted to a printed circuit board in a fixed position. Typical brake controllers can use an analog circuit. Such analog brake controllers utilize a pendulum that either breaks a light beam or a pendulum that utilizes a Hall cell and magnet.

Another alternative is to use a pendulum or a mass movement sensing device for sensing the deceleration of a towing vehicle and for operating either a mechanical or an electrical braking system in the towed vehicle. Examples of such pendulum systems are disclosed in U.S. Pat. Nos. 2,870,876 and 3,053,348. One type of electronic brake controller that includes a pendulum unit for sensing the deceleration of the towing vehicle is disclosed in U.S. Pat. Nos. 3,953,084 and 5,741,048. The pendulum of this patent is provided with a shield to block the passage of light from a light source to a light-sensing unit when the pendulum is in a resting position. When the brakes of the towing vehicle are operated and the vehicle decelerates, the pendulum will swing, permitting light to fall on the light sensing unit that then generates a proportional control signal. The brake controller is responsive to the control signal for producing a pulsed output signal having a fixed frequency and a variable pulse width proportional to the level of the control signal to apply to the brakes of the towed vehicle. However, these systems can have difficulty if the brake controller is not adjusted properly.

Finally, microprocessor based brake controllers have combined either a single axis or dual axis accelerometer with digital circuitry to automatically adjust the brake output voltage based on mounting angle of the brake controller in the vehicle. These systems can be very expensive and add significant costs to the brake controller.

### SUMMARY OF THE INVENTION

An embodiment of the present invention is directed to a brake controller. The brake controller comprises a case, a positioning member held by the case, and an accelerometer attached to the positioning member, wherein the positioning member is moveable to position the accelerometer in an operable position

According to another embodiment of the present invention a brake controller comprises a clip attachable to a vehicle, a case attachable to the clip, a positioning member attached to the case, a micro-electromechanical system accelerometer or solid state accelerometer attached to the positioning member, and wherein the positioning member is rotatable to position the micro-electromechanical system accelerometer or the solid state accelerometer in an operable position.

In yet another embodiment of the present invention a method of operating a brake controller is disclosed. The brake controller comprises a case, a positioning member attached to the case, and an accelerometer attached to the positioning member. The method comprises attaching said case to a vehicle, and positioning the accelerometer to an operable position using the positioning member.

### DESCRIPTION OF THE DRAWINGS

Objects and advantages together with the operation of the invention may be better understood by reference to the following detailed description taken in connection with the following illustrations, wherein:

FIG. 1 is a brake controller of an embodiment of the present invention attached to a clip;

FIG. 2 are a variety of views of the brake controller of an embodiment of the present invention with the clip thereon;

FIG. 3 are a variety of views of the clip of an embodiment of the present invention;

FIG. 4 are a variety of views of an embodiment of the printed circuit board holder and the positioning member and pointer in a single molded component;

FIG. 5 is an exemplary electrical schematic diagram of the electronic system of the brake controller according to an embodiment of the present invention;

FIG. 6 is block diagram of the function of the brake controller of an embodiment of the present invention; and

FIG. 7 is a simplified block diagram of the function of the brake controller of an embodiment of the present invention.

### DETAILED DESCRIPTION

The present invention utilizes a low cost micro-electromechanical system (“MEMS”) or solid-state accelerometer (e.g., Memsic MXR2999ML) to generate a proportional voltage applied to a towed vehicle's brakes based on the vehicle's deceleration rate. Other single or dual axis accelerometers, Motorola MMA2260D2, Analog Devices ADXL105, ADXL213, or other accelerometers may be used. Further, the present invention utilizes a positioning member and indicator device to properly adjust the accelerometer signal to compensate for various mounting angles of the brake controller. The proper position of the internal accelerometer sensor is a horizontal plane. The operator, by manually positioning the indicator device, such as a pointer to the down direction, accomplishes this initial condition. Fine-tuning may require the operator to adjust the positioning member to provide for either an aggressive or delayed response from the brake controller.

The brake controller of the present invention further utilizes a brake control-plastic mounting clip with adjustable mounting positions. The clip incorporates a plastic clip portion that when attached to a vehicle's mounting surface, it allows the operator to make slight mounting angle adjustments without tools so as to allow the operator to better view the display of the brake controller. Prior art mounted brake controllers either required tools for adjustments, or were not capable of multiple angle positions. Ease of use, combined with a styled and color matched appearance creates a uniform appearance of the brake control and the mounting means.

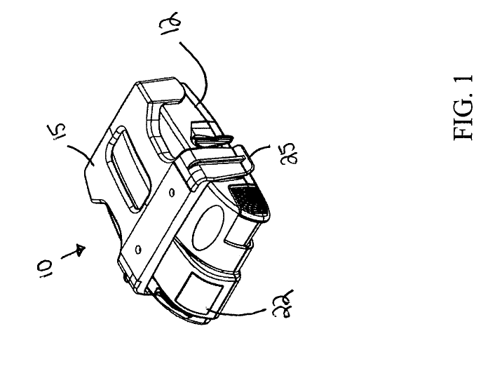

With reference to FIG. 1, a brake controller 10 for controlling the brakes of a towed vehicle of the present invention is shown. The brake controller 10 comprises a case 12, such as a plastic case. The case 12, however, can be made from just about any material, such as plastic, rubber, metal (e.g., aluminum), or a combination of such materials.

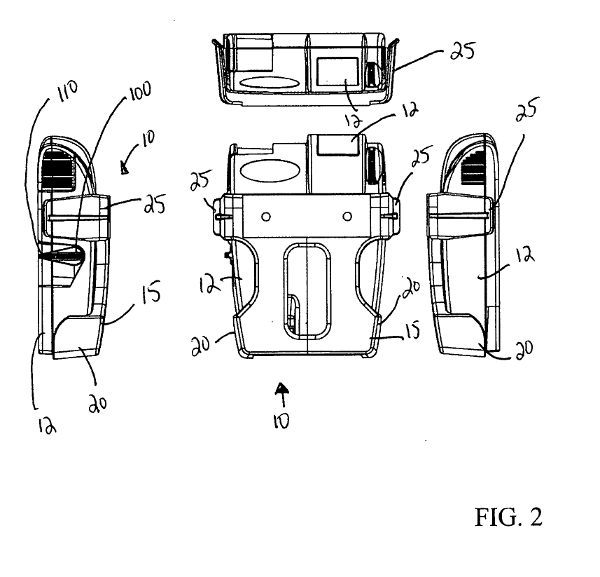

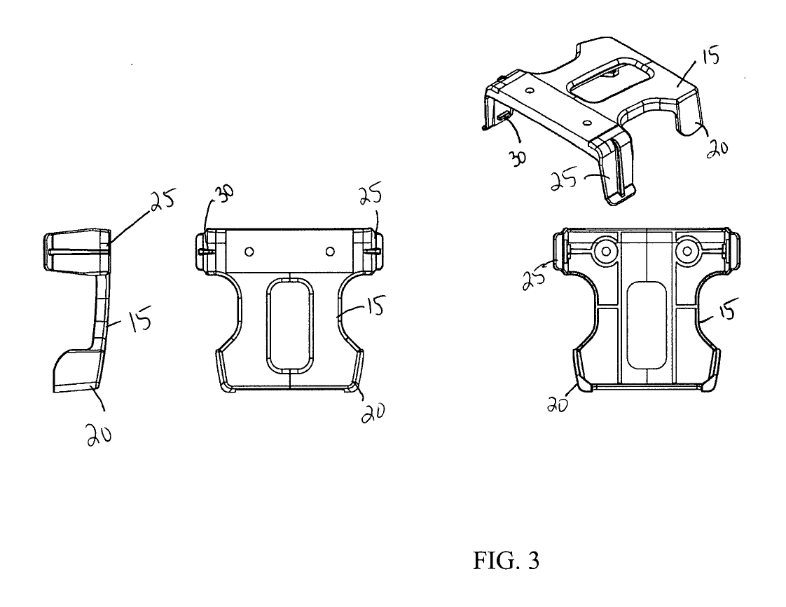

The brake controller 10 is installed on a clip 15 for ease of installation into the cab of a vehicle (not shown), and in particular, onto a vehicle's mounting surface. The clip 15 of the present embodiment includes rear supports 20, front legs 25, and mounting slots 30 as shown in FIGS. 1 through 3. It should be understood, however, that this is an exemplary embodiment and the clip 15 may take alternative embodiments and configurations. For example, the clip may be metal and may require screws to be attached to the vehicle's mounting surface. The brake controller 10 may be removably attached to the clip 15 so that it may be easily removed therefrom. Alternatively, the brake controller may be permanently fixed to the vehicle's mounting surface.

To attach the brake controller 10 to the clip 15, the brake controller 10 is placed into the rear supports 20 and is then angled into position using the front legs 25 and the mounting slots 30 on the side of the clip 15. When installed, the brake controller 10 will fit securely into the clip 15 as shown in FIG. 1. By moving apart the front legs 25, the brake controller 10 may easily be removed from the clip 15 for storage. More specifically, the clip 15 allows the brake controller 10 to be a quick disconnect clip. No tools will be needed to remove the brake controller 10 from the clip 15. An operator can use his or her hands to easily and quickly remove the brake controller 10. This allows the brake controller 10 to easily be removed from the vehicle when it is not needed. Additionally, the clip 15 can be removed from the mounting surface when the brake controller 10 is not in use.

Further, the clip 15 allows the brake controller 10 to be manually adjusted in several positions relative to the mounting surface of the vehicle. In the present embodiment, the clip 15 allows for at least three adjustable positions. However, any number of adjustable positions can be used. Adjusting the position of the brake controller 10 using the clips 15 permits the brake controller 10 to adjusted so that a display 22 of the brake controller 10 is easily visible to the operator based on its mounting angle.

When the clip 15 is mounted onto the vehicle's mounting surface and the brake controller 10 is mounted thereto, the operator may also need to make an adjustment to the printed circuit board, or more specifically, the accelerometer, based upon the mounting angle of the brake controller 10 so as to position the accelerometer in an operable position. The operator may use the clip 15 to position the brake controller 10 so as to see the display 22. This, however, may move the accelerometer in the brake controller to an inoperable position. Accordingly, the accelerometer needs to be moved to an operable position.

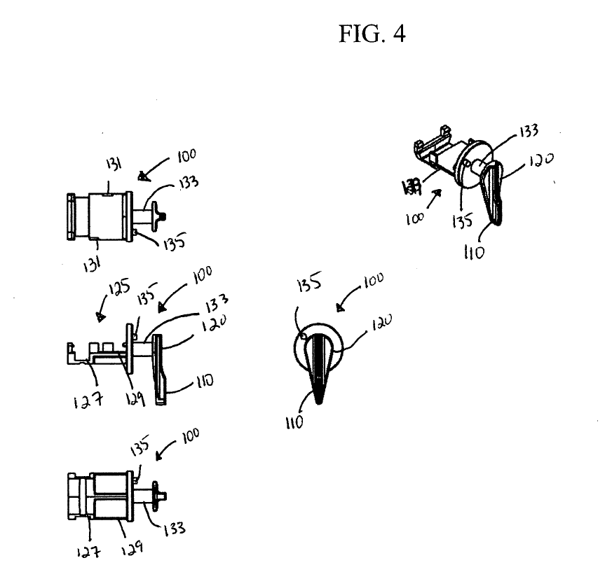

The present embodiment utilizes a positioning member 100 to adjust the printed circuit board, and, in particular, the accelerometer and its signal, to compensate for various mounting angles of the case 12 of the brake controller 10. The positioning member 100, therefore, adjusts the position of the accelerometer to place it in an operable position irrespective of the position of the brake controller 10. As shown in FIG. 4, the positioning member 100 may be a sensor-positioning arm. Alternatively, the positioning member 100 may also take other configurations not just that shown in the figures, e.g., a cylinder, a rectangular shape, an oval shape, etc. Further, the positioning member 100 includes an indicator device 110, such as the pointer shown in the figures. Alternatively, the indicator device 100 can take other configurations, e.g., a knob, a display, etc.

The operator, by manually positioning, such as by rotating, the positioning member 100 until the indicator device 110 is in the down direction, compensates for particular mounting angles of the brake controller 10. In particular, by the operator manually positioning the positioning member 100, the accelerometer of the brake controller is manually adjusted into an operable position irrespective of the position of the brake controller 10. By moving the positioning member 100, the accelerometer is moved into its operable position. The operator, further, may adjust the positioning member 100 to provide for either an aggressive or delayed response from the brake controller 10 based upon the towed vehicle weight and road surface conditions. The operator accomplishes this similarly as described above. In particular, the operator can rotate the positioning member 100 and can use the indicator device 110 as a visual reference.

More specifically, when the brake controller 10 is positioned within the cab of the vehicle, it may cause the accelerometer to be placed in an inoperable position. Accordingly, the accelerometer must be positioned to an operable position for the brake controller 10 to operate properly. To accomplish such, the operator will position the positioning member 100 until the accelerometer is in an operable position. For example, the operator can rotate an external portion 120 of the positioning member 100 until the indicator device 110 indicates that the accelerometer is in an operable position. Alternatively, the operator can rotate the positioning member 100 until the brake controller 10 indicates using a display, chime, etc. that the accelerometer is in an operable position. Thus, providing a brake controller 10 with a manually adjustable accelerometer.

The present embodiment incorporates the printed circuit board support and holder, and the external portion 120 of the positioning member 100 and indicator device 110 in a single molded component, as is shown in FIG. 4. The single piece design incorporates a printed circuit board support and holder 125 where both ends serve as a card guide 127 and board support holder 129. Additional printed circuit board side supports 131 secure the printed circuit board securely from side to side. A bearing surface 133 is also incorporated into the same single molded plastic piece. The opposite bearing support surface piece can be integrated into the side of the case or can be a separate piece. Finally, the single piece incorporates anti-rotation stops 135 to limit the angular travel to be within the desired range to prevent over rotation of the positioning member 100.

In order to assemble the brake controller 10, the accelerometer printed circuit board is placed in the front board slot between the two side alignment pieces. The printed circuit board is then pressed down and snapped into place. The two rear locking latches hold the printed circuit board securely. The positioning member 100 and accelerometer printed circuit board are then pushed into the bearing support that is part of the case 12 side.

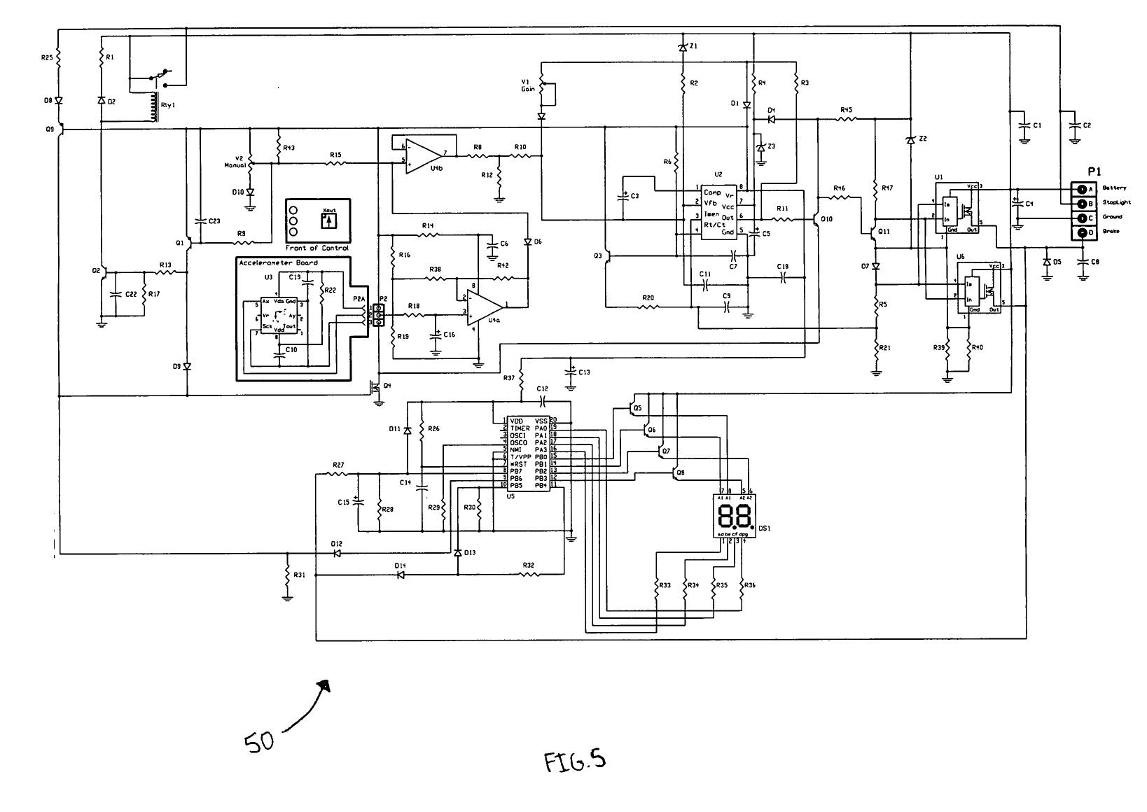

The brake controller 10 further includes an electronic circuit 50, depicted in FIG. 5. The electronic circuit 50 utilizes a micro-electromechanical system (“MEMS”) accelerometer with linear control circuitry. The operator can physically adjust the attitude of the accelerometer to provide aggressive or delayed braking to satisfaction. Additionally, the aggressiveness of the current brake controller 10 will increase when traveling downgrade and decrease when traveling upgrade. Many operators view this as an advantage because it automates what the operator would likely done anyway.

The current brake controller 10 utilizing the electronic circuit 50, has two modes of operation, manual and automatic. The manual control is smoother than in prior art brake controllers. In particular, it spreads the application of brakes over most of the range of the potentiometer. The automatic mode has also been made as smooth as possible.

In an embodiment of the brake controller 10, it utilizes a current-mode PWM control I.C., U2, known as a UC2843/UC3843 High Performance Current Mode PWM Controller made by several manufacturers. The I.C. operates with an internal current-mode loop wrapped by a voltage control loop. This is used with the magnetic load that is presented by the brake magnets. Every pulse initiated by the clock circuit is terminated when the load current reaches the request level. The request level is set by the voltage loop. This technique is automatically short circuit or overload proof.

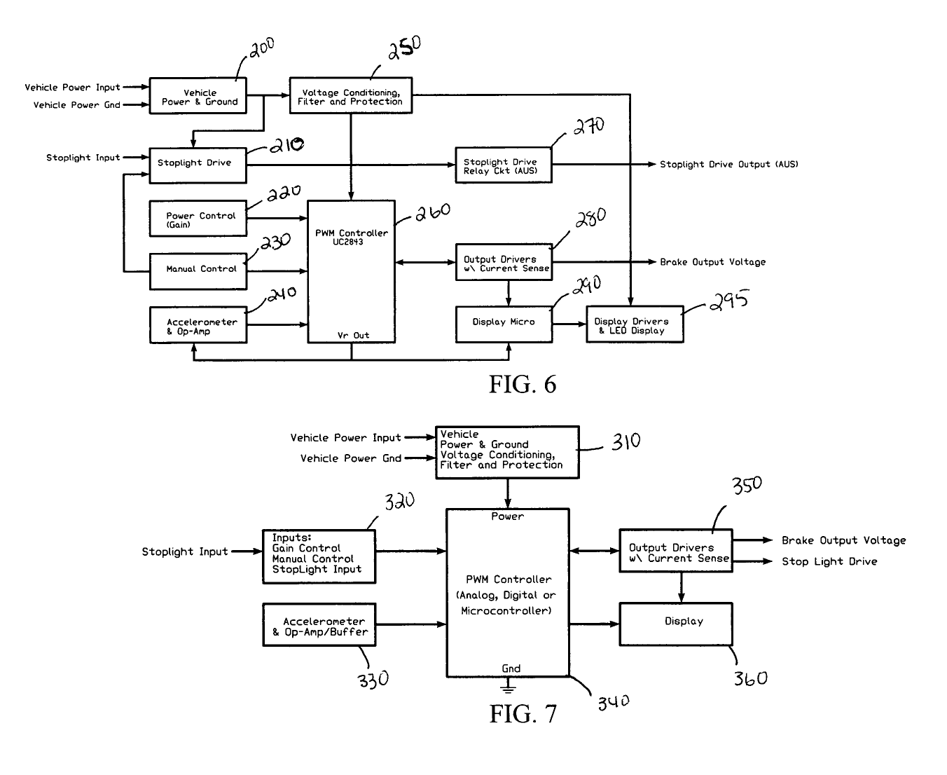

As depicted in FIG. 5, the UC2843/UC3843 (U2) clock is operated at between 250 Hz and 300 Hz as set by R6 and C7 of the electronic circuit 50. C7 also sets the minimum off time or maximum duty cycle. Maximum duty cycle is set at about 97%. The inputs to the UC2843/UC3843 (U2) are generated by the manual control and the accelerometer as shown in FIGS. 6 and 7. The circuit 50 is set up so that the strongest signal dominates.

The voltage on the wiper of V2 moves from 5 volts to about 0.6 volts over the entire stroke. U4b is a buffer to isolate the divider on its output from the “or” circuit on its input. The accelerometer is connected via D6 to the junction of R15 and U4b, pin 5. Both the manual and the accelerometer signal start near 5 volts and go to near 0 volts. D10 and D6 match the range of the two inputs and yield the “or” function.

The error amplifier in the UC2843/UC3843 (U2) is internally referenced to 2.5 volts. To minimize delay at turn on, the input on pin 2 draws a very small amount of current during idle. The ratio of voltage divider (R8 and R12) is slightly less than 0.5. With the voltage at the junction slightly below 2.5 volts, R10 will draw a few micro-amps from pin 2. Since pin 2 is a summing node the output of the internal error amp will be driven upward until the output pulses on pin 6 drive enough current through the gain control circuit (V1, D3, D1, and R3) to offset the current being pulled through R10. Because Q10 is not enabled during idle these very narrow pulses do not reach U1 and U6. They only maintain U2 at the very edge of turn on.

As manual control (V2) moves down from 5 volts it drives Q1 on. Q1 in turn activates the optional relay (Rly 1) via Q2 and enables the voltmeter via D8. Q1 also drives the gate of Q4 turning on the accelerometer circuit and enabling the drive from U2 pin 6 to be connected to the input (pin 2) of the high side drivers U1 and U6.

As V2 moves down it now provides drive to the error amplifier in U2 through the aforementioned network between the wiper of V2 and U2 pin 2. Since U1 is now driven (U6 is optional for a higher power unit) it delivers pulses from pin 5 to P1 pin D. These pulses will increase in width until the average current through the gain circuit into U2 pin 2 equals the current pulled out of pin 2 through R10. This current is a function of the duty cycle and the setting of V1. The higher the setting of V1 the higher the duty cycle required to offset the current pulled out by R10.

Returning to the idle mode, a stoplight signal is now applied to P1 pin B. When this signal exceeds approximately 6.2 volts Q9 operating in a common base mode will be turned on. The collector of Q9 will enable the voltmeter and through Q4 will activate the accelerometer and enable the output coupling of U2 to U1.

The accelerometer U3 is mounted on a small printed circuit board such that its active axis is oriented in the direction of travel of the tow vehicle. The accelerometer output voltage is 2.5 volts when it is substantially horizontal. The accelerometer is mounted on a circuit board platform such that the attitude of the accelerometer can be rotated about a horizontal axis transverse to the direction of travel, as previously described. In particular, the accelerometer is mounted on the printed circuit board, which is mounted to the positioning member 100. The positioning member 100 is positionable such that the accelerometer can be positioned to a substantially horizontal axis transverse to the direction of travel.

This allows the accelerometer to be “leveled” to accommodate various mounting angles of the brake controller 10. In particular, if the brake controller 10 is mounted such that the accelerometer is not in an operable positioning, the operator may rotate the positioning member 100, until the accelerometer is “leveled” and is operable. This also allows the driver to adjust the accelerometer to yield an aggressive or delayed setting. An aggressive setting starts out yielding a brake output of perhaps 1 to 3 volts when the brake pedal is initially pressed. To accomplish this, the operator can rotate the positioning member 100 until the accelerometer is slightly angled (as if the brake controller 10 where going downhill). A delayed setting yields a brake output that requires some actual braking of the tow vehicle before the control begins any output voltage. This is accomplished by moving the angle of the positioning member 100, or more specifically, the indicator device 110 slightly towards the front of the vehicle or in the direction of travel.

When activated by Q4 in response to an input from either the manual or stoplight signal, the output of the accelerometer as used here starts with an output of approximately 2.5 volts when it is substantially horizontal and moves downward 1 volt per G of deceleration. As the normal range of deceleration involved in stopping seldom exceeds 0.5 G corresponding to 0.5 volts it is necessary to apply gain and offset to this signal. The circuitry around U4a provides this functionality and the diode D6 couples it into the “or” circuit discussed earlier. An RC circuit on the input to U4a provides a single pole of low pass to restrict the frequency response of the circuit.

As in manual activation the signal is applied to U4b connected as a buffer. Again as the signal moves down, current is drawn from the summing node of the error amplifier in U2. The control responds by increasing the pulse width (duty cycle) of the output keeping the output proportional to the accelerometer demand signal. The capacitor C3 in conjunction with R10 provides another pole of low pass filtering. The error amplifier is configured as an integrator with open loop gain of about 90 db (about 33000).

The VN920 high current output driver comprises an N-channel MOSFET and charge pump circuitry to drive the gate of the MOSFET. It also has a built in current mirror with level translator and various protection circuitry to make the device nearly indestructible. The translated current mirror signal is used as the feedback for the UC2843/UC3843 current loop. This signal is generated as a current source at pin 4 of the VN920. R5 and R21 convert this signal to a voltage to be used by the UC2843/UC3843 to close the loop.

Current mode controls such as this have instability when operated at greater than 50% duty cycle. It may, therefore, be necessary to apply slope compensation in proportion to the negative slope of the magnetic circuit. This is the rate of decay of current in the magnets while the output is off. During this time the current is flowing through D5. The inductance and resistance of the load in conjunction with the forward drop of the flyback diode D5 establish the decay rate.

At high duty cycle the current sense signal gets rather flat and a small amount of noise on the signal can cause the pulse to terminate early or late. It can be shown that such a perturbation will not converge and damp out but will instead grow to the point of skipping entire pulses. This is referred to as sub-harmonic oscillation. The problem is especially difficult because of the wide variation in load. The control is intended to drive 2, 4, or 6 brake magnets. On the other hand, too much compensation defeats the current mode operation and turns the circuit back to a voltage loop.

An appropriate signal can be added to the current sense signal to cause it to intersect the threshold at a steeper angle. This signal is taken from the saw-tooth oscillator on U2 pin 4. An emitter follower (Q3) is used to reduce the load on the oscillator. This signal coupled through R20 to the signal developed across R21 provides adequate compensation over all conditions.

Q10 and Q11 perform multiple functions. First they permit gating the drive signal to U1 and U6. Second they provide load dump protection for the VN920. During a load dump the vehicle may be at maximum alternator current output when the connection to the battery opens. Since the regulator does not respond immediately the alternator voltage may rise to 60 or 70 volts for up to 300 ms.

A simple transfer from ground to Vbatt would have to be very large to withstand this transient and protect the circuitry. Placing a resistor in the ground leg of the VN920 (pin 1) and a zener diode from pin 1 to Vbatt prevents excess voltage from being applied to the control portion of the VN920. With 100 ohms in the ground leg (R39) the ground offset is only 0.5 volts while the VN920 is on since the ground current is only 5 ma. Additionally, by grounding the emitter of Q11 to the top of R39 the voltage rise on R39 during a load dump turns off Q11 and turns on U1 and U6. This reduces the voltage across the embedded MOSFET to about 0.5 volts and delivers the load dump pulse to the brake magnets that can handle the energy with ease.

More protection is provided by Z1 and R2. Without these components if the connection to ground is accidentally lifted and the control is activated the absence of ground can cause the unit to not operate properly. Initially the control will find ground through D5 and the load. When the control is activated the flyback during the off time will act as boost type power supply and generate a very high voltage across C4. The positive terminal of C4 will of course stay at Vbatt while the negative terminal will drive negative until some circuit element breaks down.

With Z1 and R2 in the circuit any voltage above about 18.5 volts will cause the control to cut back duty cycle. (The zener at 16 volts and the 2.5 volt summing node voltage add up to 18.5.) Voltage above this level will drive current into the summing node and drive pin 1 of U2 low. The duty cycle will go to zero until the voltage on C4 decays. If the situation still exists the pattern will repeat. This will continue until the control is no longer activated or the ground is reconnected. Additionally, Z3 and R4 protect U2 from excessive voltage.

During load dump the Is terminal of the VN920 is protected from going more than 0.6 volts below pin 1 by D2. This results in the difference between the load dump voltage and Z3 appearing across R5 and R21 series combination. R5 in this case reduces the total dissipation during load dump. The circuit could function without R5 but the dissipation in R21 would be excessive during load dump.

U5 and the circuitry surrounding U5 perform a dual function. The primary function is that mentioned previously, e.g., a voltmeter. The RC filter of R27 and C15 present an average of the output of the brake controller 10 to the A to D input of U5. The software reads this voltage and presents it to the operator via a dual seven-segment display.

Additionally, the software periodically tests the load on the brake controller 10. Pin 11 drives current into the output through R32. If a magnet load is present the output will not rise significantly and no voltage will be seen on pin 10. The display will show “.c”. If there is no load the display will show “.”. If a load is present and then is disconnected the display will flash “n.c” for about 15 seconds.

While the circuit described is an embodiment there are of course many equivalents. The chosen accelerometer is a thermal based device but there are capacitance devices available that would serve the same purpose. In fact there may be devices in development using other technologies. All that is of concern is that the device generates a voltage in proportion to acceleration. The functions of the control chip (UC2843/UC3843 (U2)) could be embodied in other control chips or a microprocessor. A single microprocessor could encompass the control function as well as the display and test functions. The VN920 high side switch has many equivalents. An equivalent could even be assembled from discrete parts. Also, while the VN920 utilizes an N-channel MOSFET, a P-channel MOSFET based solution could be used.

As shown in FIG. 6, an embodiment of the brake controller 10 includes a vehicle power and ground 200, a stop light drive 210, a power control 220 (gain), a manual control 230, an accelerometer and op-amp 240, a voltage conditioning filter and protection 250, a PWM controller 260, a stoplight drive relay 270, output drivers with current sense 280, a display micro 290, and display drivers and LED display 295. As shown in FIG. 6, the vehicle power and ground 200 is capable of receiving vehicle power input and vehicle power ground input. Further, the vehicle power and ground 200 is capable of sending signals to the voltage-conditioning filter and protection 250 and the stoplight drive 210. The stoplight drive 210 is capable of receiving stoplight input signals and signals from the vehicle power and ground 200 and the manual control 230. The accelerometer and op-amp 240 is capable of receiving PWM controller 260 signals. The PWM controller 260 is capable of receiving signals from the voltage conditioning filter and protection 250, the power control 220, the manual control 230, the accelerometer and op-amp 240, and the output drivers with current sense 280. The voltage conditioning filter and protection is capable of receiving signals from the vehicle power and ground 200. The stoplight drive relay is capable of receiving signals from the stoplight drive 210 and capable of sending a stoplight drive output signal. The output drivers 280 are capable of sending and receiving signals from the PWM controller 260 as well as sending signals to the display micro 290 and the brake output voltage. The display micro 290 is capable of receiving signals from the output drivers with current sense 280 and the PWM controller 260 and sending signals to the display drivers and LED display 295. The display drivers and LED display 295 is capable of receiving signals from the voltage conditioning filter protection 250 and display micro 290.

As shown in FIG. 7, an embodiment of the brake controller 10 includes vehicle power and ground voltage conditioning filter and protection 310, inputs 320, accelerometer and op-amp buffer 330, PWM controller 340, output drivers with current sense 350, and display 360. The inputs may include gain control, manual control, and stoplight input. The input 320 is capable of receiving signals from the stoplight input and is capable of sending signals so the PWM controller 340. The accelerometer and op-amp 330 is capable of sending signals to the PWM controller 340. The vehicle power and ground voltage conditioning filter and protection 310 is capable of receiving signals relating to vehicle power input and vehicle power ground and is capable of sending signals to the PWM controller 340. The output drivers with current sense 350 are capable of sending and receiving signals from the PWM controller 340 and are capable of sending signals relating to brake output voltage and stoplight drive. Finally, the display 360 is capable of receiving signals from the output drivers with current sense 350 and the PWM controller 340.

Although certain embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications, and substitutions without departing from the scope of the claims hereafter.

Having thus described the invention, we claim:

1. A brake controller comprising:
a case;
a positioning member held by said case; and
an accelerometer attached to said positioning member, wherein said positioning member is moveable to position said accelerometer in an operable position.

2. The brake controller of claim 1, wherein said positioning member is rotatably attached to said case to position said accelerometer in said operable position.

3. The brake controller of claim 2, wherein said positioning member is one-piece.

4. The brake controller of claim 3, wherein said positioning member further comprises an indicator device to indicate when said accelerometer is in said operable position.

5. The brake controller of claim 4, wherein said positioning member comprises a sensor positioning arm and said indicator device comprises a pointer.

6. The brake controller of claim 5, further comprising:
a clip for attaching said case to a vehicle;
a display included in said case; and
wherein said clip permits said case to be moveable to position said display for viewing.

7. The brake controller of claim 6, wherein said clip is removably attached to said vehicle.

8. The brake controller of claim 7, wherein said case is removably and rotatably attached to said clip.

9. A brake controller comprising:
a clip attachable to a vehicle;
a case attachable to said clip;
a positioning member attached to said case;
a micro-electromechanical system accelerometer or solid state accelerometer attached to said positioning member; and
wherein said positioning member is rotatable to position said micro-electromechanical system accelerometer or said solid-state accelerometer in an operable position.

10. The brake controller of claim 9, further comprising a display included in said case.

11. The brake controller of claim 10, wherein said case is removably and rotatably attached to said clip to position said display for viewing by an operator of said vehicle.

12. The brake controller of claim 11, wherein said positioning member comprises an indicator device to indicate when said micro-electromechanical system accelerometer or said solid state accelerometer is in said operable position.

13. The brake controller of claim 12, wherein said positioning member is one-piece.

14. A method of operating a brake controller, wherein said brake controller comprises a case, a positioning member attached to said case, and an accelerometer attached to said positioning member, said method comprising:
attaching said case to a vehicle; and
positioning said accelerometer to an operable position using said positioning member.

15. The method of claim 14, wherein positioning said accelerometer to said operable condition comprises rotating said positioning member.

16. The method of claim 15, wherein said positioning member comprises an indicator device to indicate when said accelerometer is in said operable position.

17. The method of claim 16, wherein positioning said accelerometer to said operable condition comprises rotating said positioning member until said indicator device indicates said accelerometer is in said operable position.

18. The method of claim 17, further comprising rotatably attaching said case to a clip and attaching said clip to said vehicle.

19. The method of claim 18, further comprising rotating said case in said clip until a display can be viewed by an operator of said vehicle.

20. The method of claim 19, wherein said accelerometer is a micro-electromechanical system accelerometer or a solid-state accelerometer.
